(19) United States
(12) Patent Application Publication
(10) Pub. No.: US 2014/0373702 A1
(43) Pub. Date: Dec. 25, 2014

(54) TIMBRE PROCESSING ADAPTER SOCKET FOR ELECTRIC GUITAR

(71) Applicant: MICROTIPS TECHNOLOGY INC., NEW TAIPEI CITY (TW)

(72) Inventors: I-Yun HUANG, New Taipei City (TW); Chao-Ting CHENG, Taipei City (TW)

(73) Assignee: MICROTIPS TECHNOLOGY INC., NEW TAIPEI CITY (TW)

(21) Appl. No.: 14/147,574

(22) Filed: Jan. 5, 2014

(30) Foreign Application Priority Data
Jun. 21, 2013 (TW) 102211693

(51) Int. Cl. G10H 3/18

(52) U.S. Cl. CPC G10H 3/18
USPC 84/735

(57) ABSTRACT

A timbre processing adapter socket for electric guitar is provided, including a socket body and a fixing unit. The socket body includes a groove seat and an assembling seat connected with each other. The groove seat has an accommodation groove, and a signal transmitter is arranged on an inner end portion of the accommodation groove. A timbre processor is accommodated in the accommodation groove and further electrically connected to the signal transmitter. The assembling seat is provided with an audio input hole, a timbre processing signal output hole, at least one speaker and at least one battery connected with each other electrically. The fixing unit fixes the socket body detachably on an external end portion of the electric guitar.

### RELATED APPLICATIONS

This application claims priority to Taiwan Application Serial Number 102211693, filed Jun. 21, 2013, which is herein incorporated by reference.

### BACKGROUND

1. Technical Field

The present disclosure relates to an adapter socket, and specifically to a timbre processing adapter socket structure for an electric guitar.

2. Description of Related Art

The electric guitar is one of essential musical instruments for popular music concert. In order to improve the performing effect of guitar, a player often serially connect a plurality of guitar effect processors to a voice box and an audio output hole of the electric guitar via a connecting cable. The guitar effect processor has a function of processing timbre, which can change the timbre of a guitar sound signal, such that using different guitar effect processors can enable the music played by the player through the electric guitar to have different timbres, thereby improving the performing effect of guitar.

However, the plural guitar effect processors occupy a large volume and the connecting cables are in a mess, and additionally during performance of the popular music concert, performing actions of singers and instrument players (hereafter referred to as players) are often very violent in a wide range, such that the guitar effect processors and connecting cables laid on the floor sometimes may cause constrains to performing actions of the players and make the connecting cables drop off, and even cause accidental harm to the players.

In recent years, a smart phone or music displayer developed by the communication industry can have the function as timbre processor by downloading applications for guitar timbre processing, thereby a combination of a signal transmitter and such a timbre processor becomes another choice for changing the timbre of music in addition to conventional guitar effect processors. The total volume of the signal transmitter and the timbre processor is smaller than that of a guitar effect processor, but it still needs to connect the audio output hole of the electric guitar through connecting cables to the signal transmitter and timbre processor placed on the floor or a platform, wherein the connecting cables extend in a mess, which affects the exercise convenience and causes constrains and accidental harm to the player.

### SUMMARY

The present disclosure provides a timbre processing adapter socket for an electric guitar, which is not constrained by connecting cables.

According to an aspect of the present disclosure, a timbre processing adapter socket for electric guitar is provided, including a socket body and a fixing unit. The socket body includes a groove seat and an assembling seat. The groove seat has an accommodation groove, and a signal transmitter is arranged on the inner end portion of the accommodation groove, such that a timbre processor can be accommodated in the accommodation groove and further connected electrically to the signal transmitter. The assembling seat is connected to the groove seat, and the assembling seat is provided with an audio input hole, a timbre processing signal output hole, at least one speaker and at least one battery. The audio input hole is electrically connected to the signal transmitter. The timbre processing signal output hole and the speaker are electrically connected to the timbre processor. The battery is electrically connected to the speaker. The fixing unit fixes the socket body detachably on an external end portion of the electric guitar.

According to an embodiment of the present disclosure, a screw fixing hole is arranged on the external end portion of the electric guitar, the assembling seat of the socket body has a combination plate in which an open slot is provided; the fixing unit includes a screw fixing member and a fixing ring, wherein the screw fixing member has a hollow combination column and an outer block body which are integrated with each other, wherein the hollow combination column is provided with an external screw thread, and an internal screw protruding outwardly is accommodated in the hollow combination column, the fixing ring is provided with a screw hole for screwing to the external screw thread of the hollow combination column, the hollow combination column of the screw fixing member passes through the open slot, and the internal screw is screwed into the screw fixing hole, and the fixing ring is screwed tight to enforce the combination plate to move close to the external end portion of the electric guitar.

According to an embodiment of the present disclosure, a soft gasket is arranged on a surface of the fixing ring facing the socket body.

According to an embodiment of the present disclosure, the connection between the assembling seat and the groove seat is shown as an L shape, and the groove seat and the assembling seat respectively cross against a top surface and a side surface of the external end portion of the electric guitar.

According to an embodiment of the present disclosure, the groove seat and the assembling seat are respectively provided with a soft gasket on a surface facing the external end portion of the electric guitar.

For the timbre processing adapter socket for electric guitar according to an aspect of the present disclosure, the timbre processing adapter socket is installed on the electric guitar, such that a player can operate the timbre processor very conveniently, and furthermore the guitar cable connected between the audio output hole of the electric guitar and the audio input hole of the socket body of the adapter socket also adheres to the electric guitar, such that the guitar cable do no constrain or accidental harm to the player.

### BRIEF DESCRIPTION OF THE DRAWINGS

FIG. 1 is a schematic appearance view of a timbre processing adapter socket for electric guitar according to an embodiment of the present disclosure;

FIG. 2 is an enlarged exploded view of the timbre processing adapter socket for electric guitar as shown in FIG. 1;

FIG. 3 is a constitution diagram of the timbre processing adapter socket for electric guitar as shown in FIG. 2;

FIG. 4 is a schematic cross-sectional view of a combination of the fixing unit and socket body of the timbre processing adapter socket for electric guitar with the electric guitar;

FIG. 5 is a circuit block diagram of the timbre processing adapter socket for electric guitar as shown in FIG. 1;

FIG. 6 is one of two schematic utilization views of the timbre processing adapter socket for electric guitar according to an embodiment of the present disclosure; and

FIG. 7 is the other one of two schematic utilization views of the timbre processing adapter socket for electric guitar according to an embodiment of the present disclosure.

### DETAILED DESCRIPTION

The foregoing and other technical contents, features and functions of the present disclosure will be clearly presented through the following detailed description of embodiments with reference to the accompanying drawings.

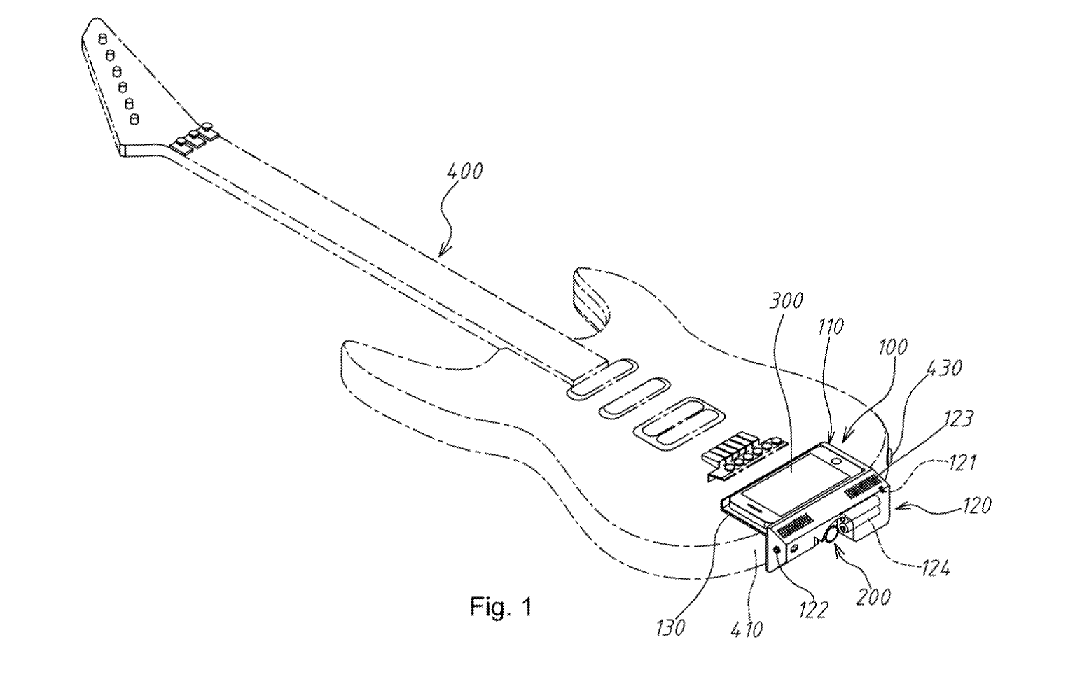

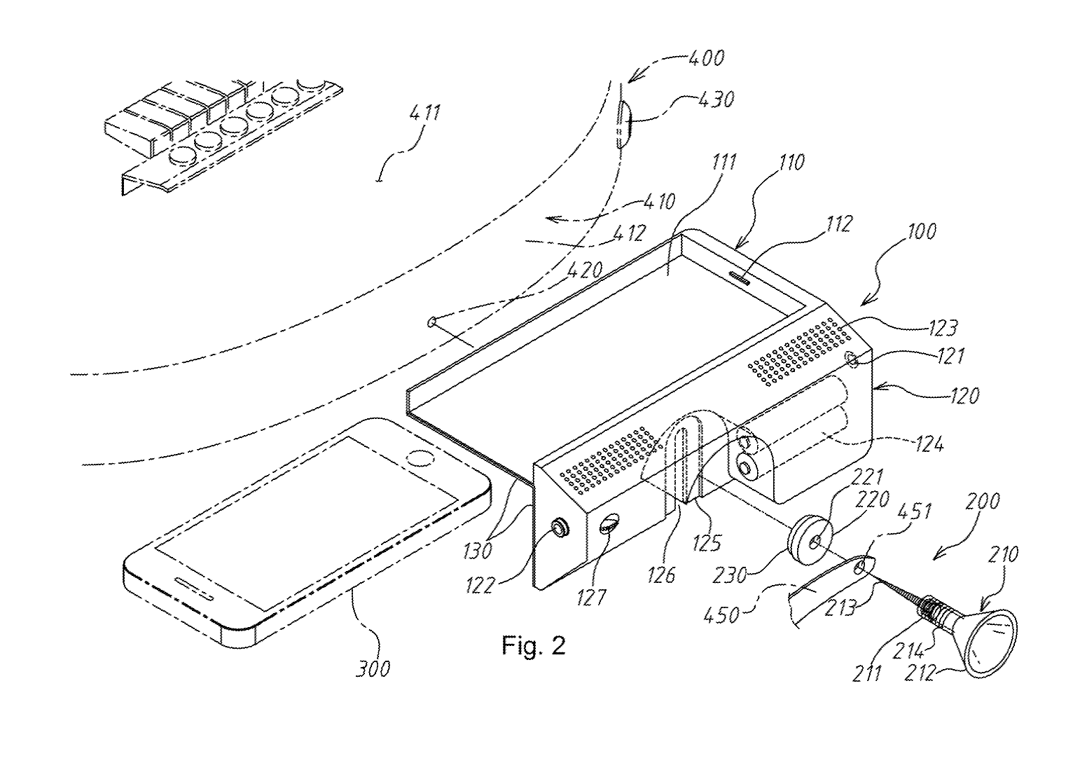

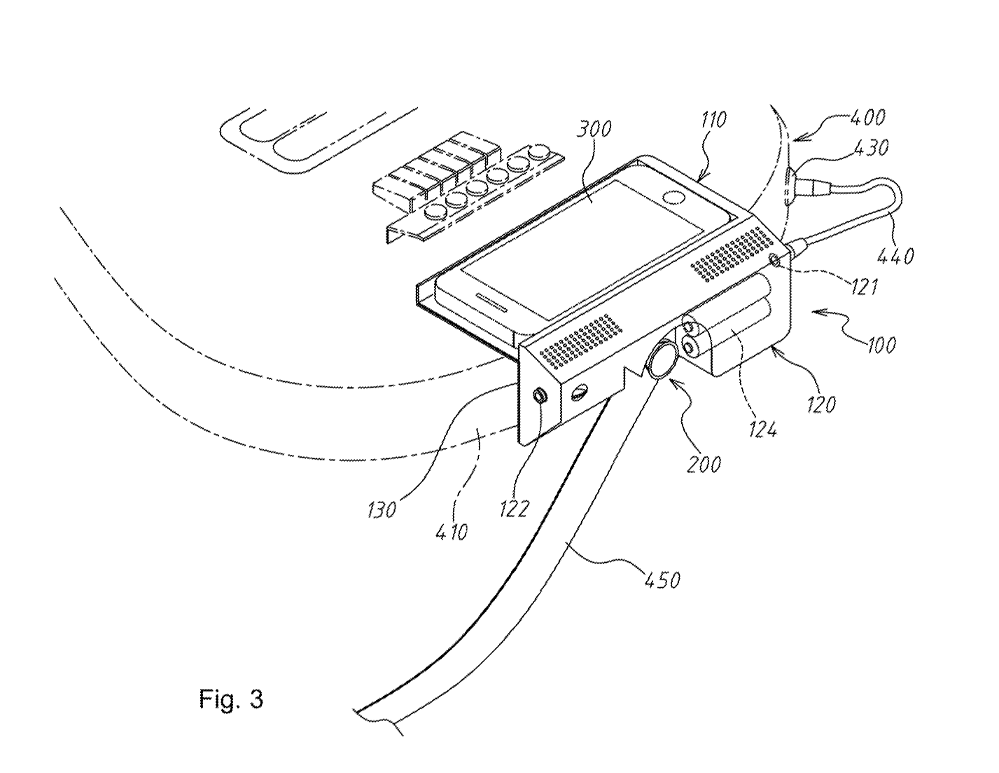

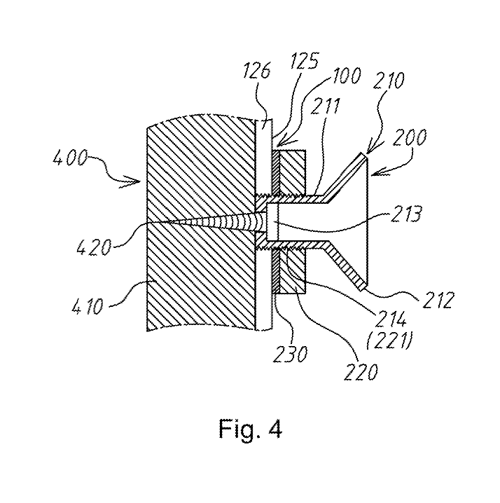

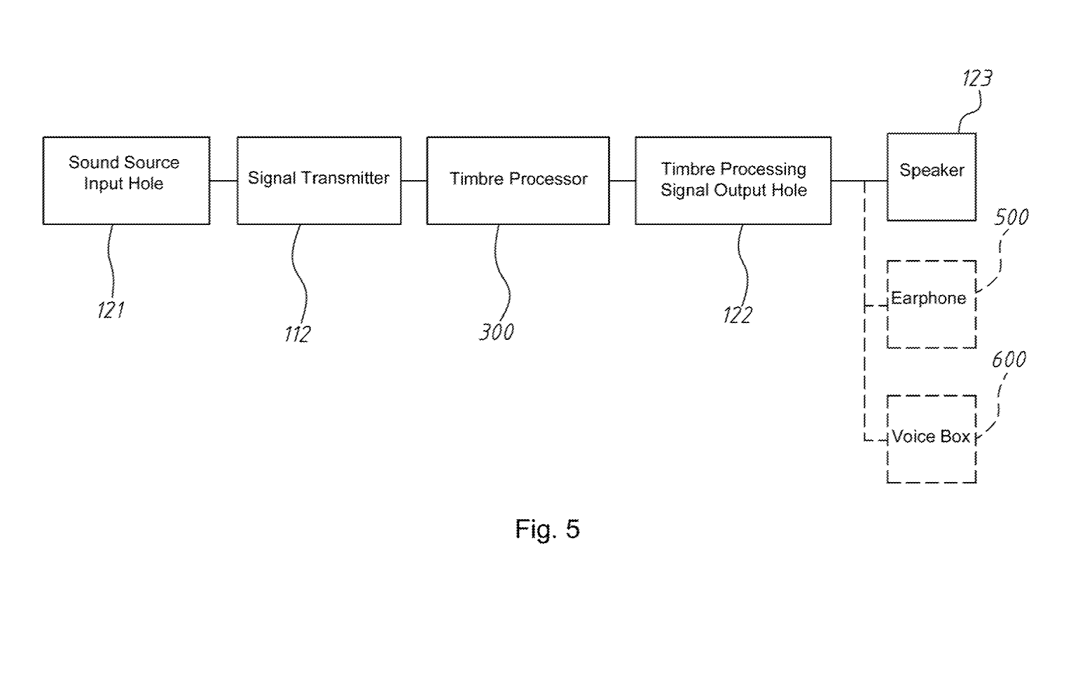

Referring to FIGS. 1 to 5, a timbre processing adapter socket for an electric guitar according to an embodiment of the present disclosure includes a socket body 100 and a fixing unit 200.

The socket body 100 includes a groove seat 110 and an assembling seat 120. The groove seat 110 has an accommodation groove 111, and a signal transmitter 112 is arranged on an inner end portion of the accommodation groove 111. A timbre processor 300 such as a smart phone with the timbre processing function can be accommodated in the accommodation groove 111 and further connected electrically to the signal transmitter 112.

The connection between the assembling seat 120 and the groove seat 110 is shown as an L shape. The groove seat 110 and the assembling seat 120 respectively cross against a top surface 411 and a side surface 412 of an external end portion 410 of an electric guitar 400, such that the socket body 100 can steadily cross against the external end portion 410 of the electric guitar 400. The groove seat 110 and the assembling seat 120 are respectively provided with a soft gasket 130 on a surface facing the external end portion 410 of the electric guitar 400, so as to avoid surface abrasion of the electric guitar 400 due to the socket body 100.

The assembling seat 120 is provided with an audio input hole 121, i.e. a sound source input hole 121, a timbre processing signal output hole 122, a speaker 123 and two batteries 124. The audio input hole 121 is an audio input hole of an electric guitar or a bass, which may be electrically connected with an audio output hole 430 of the electric guitar 400 or bass (not shown) through a guitar cable 440 so as to input a sound source signal of music played by means of the electric guitar 400 from the audio output hole 430 into the timbre processor 300 via the audio input hole 121 and the signal transmitter 112. The timbre processing signal output hole 122 and the speaker 123 are electrically connected to the timbre processor 300, so as to output a timbre processing signal processed by the timbre processor 300 into the timbre processing signal output hole 122 and the speaker 123. The battery 124 is electrically connected with the speaker 123, so as to directly supply power to the speaker 123 for ensuring the sound source stability during working time of the speaker 123. Additionally, the assembling seat 120 is provided with a switch and volume adjuster 127. The switch and volume adjuster 127 is electrically connected to the timbre processing signal output hole 122 and the speaker 123 so as to control on or off of the electric guitar music and control the volume of speaker or earphone.

A fixing unit 200 is used for fixing the socket body 100 detachably on the external end portion 410 of the electric guitar 400. The fixing unit 200 includes a screw fixing member 210 and a fixing ring 220. The screw fixing member 210 has a hollow combination column 211 and an outer block body 212 which are integrated with each other. The hollow combination column 211 has an external screw thread 214, An internal screw 213 protruding outwardly is accommodated in the hollow combination column 211. The fixing ring 220 is provided with a screw hole 221 for screw fitting the external screw thread 214 of the hollow combination column 211.

A screw fixing hole 420 is arranged on the side surface 412 of the external end portion 410 of the electric guitar 400. The assembling seat 120 of the socket body 100 has a combination plate 125, in which an open slot 126 is established. The open slot 126 has a sufficient length range, such that the position of the open slot 126 can be kept corresponding to the screw fixing hole 420 at any time according to different thicknesses of the side surface 412 of the external end portion 410 of the electric guitar 400. For the fixing unit 200, the hollow combination column 211 of the screw fixing member 210 passes through the open slot 126 of the socket body 100, and the internal screw 213 of the hollow combination column 211 is screw fixed into the screw fixing hole 420 of the electric guitar 400. Furthermore, the fixing ring 220 is screwed tight to enforce the combination plate 125 of the socket body 100 to move close to the external end portion 410 of the electric guitar 400. Accordingly, the fixing unit 200, the socket body 100 and the electric guitar 400 are combined and fixed together. The space of the hollow combination column 211 between the fixing ring 220 and the outer block body 212 can be buckled into the buckling hole 451 on the strap 450 of the electric guitar 400 for fixation.

A soft gasket 230 is arranged on a surface of the fixing ring 220 facing the combination plate 125 of the socket body 100, so as to achieve the function of packing tight while avoiding surface abrasion of the socket body 100 due to the fixing ring 220.

For the timbre processing adapter socket for electric guitar according to an embodiment of the present disclosure, a music signal of the music played by means of the electric guitar 400 is transferred to the timbre processor 300 through the audio output hole 430, the audio input hole 121 and the signal transmitter 112 in sequence; and then the music signal with the timbre processed by the timbre processor 300 is output to the timbre processing signal output hole 122 and the speaker 123, such that the music played back by the speaker is music with the processed timbre, which enables the music played by means of the electric guitar to show different timbres, improving the performing effect of guitar. In particular, the timbre processing adapter socket of the present disclosure is installed on the electric guitar 400, such that a player can operate the timbre processor 300 conveniently. Furthermore, the guitar cable 440 connected between the audio output hole 430 of the electric guitar 400 and the audio input hole 121 of the socket body 100 of the adapter socket also adheres to the electric guitar 400 and oscillates along with the electric guitar 400, rather than extending on the floor in a mess, such that the guitar cable 440 do no constrain or accidental harm to the player.

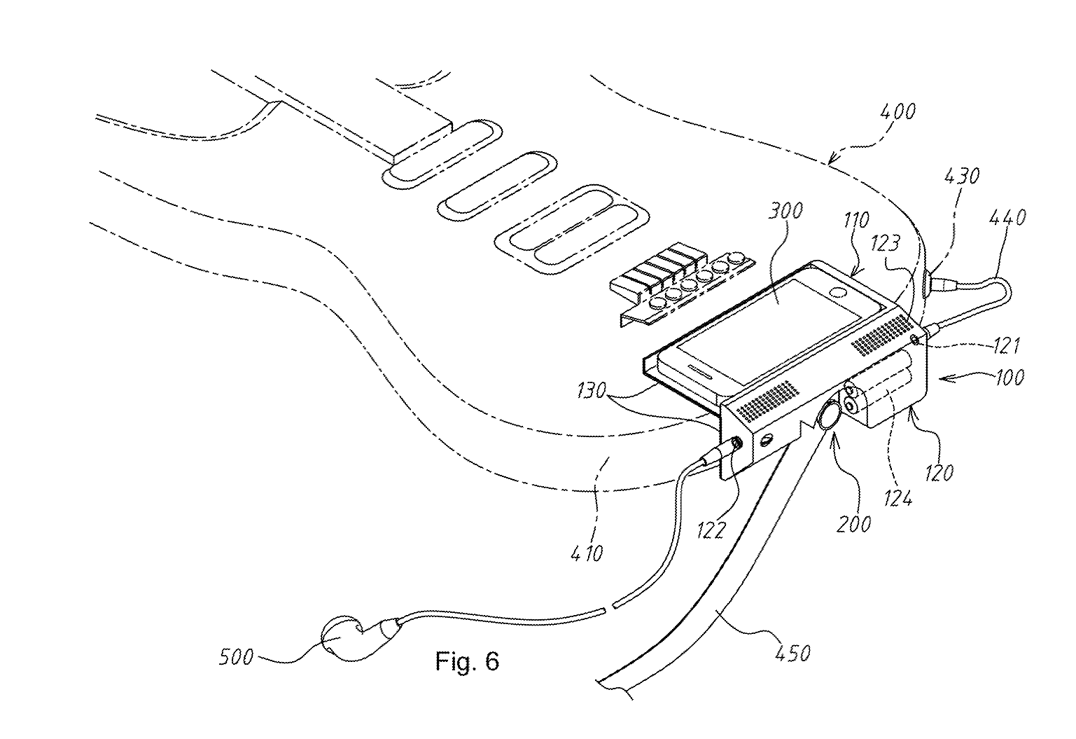

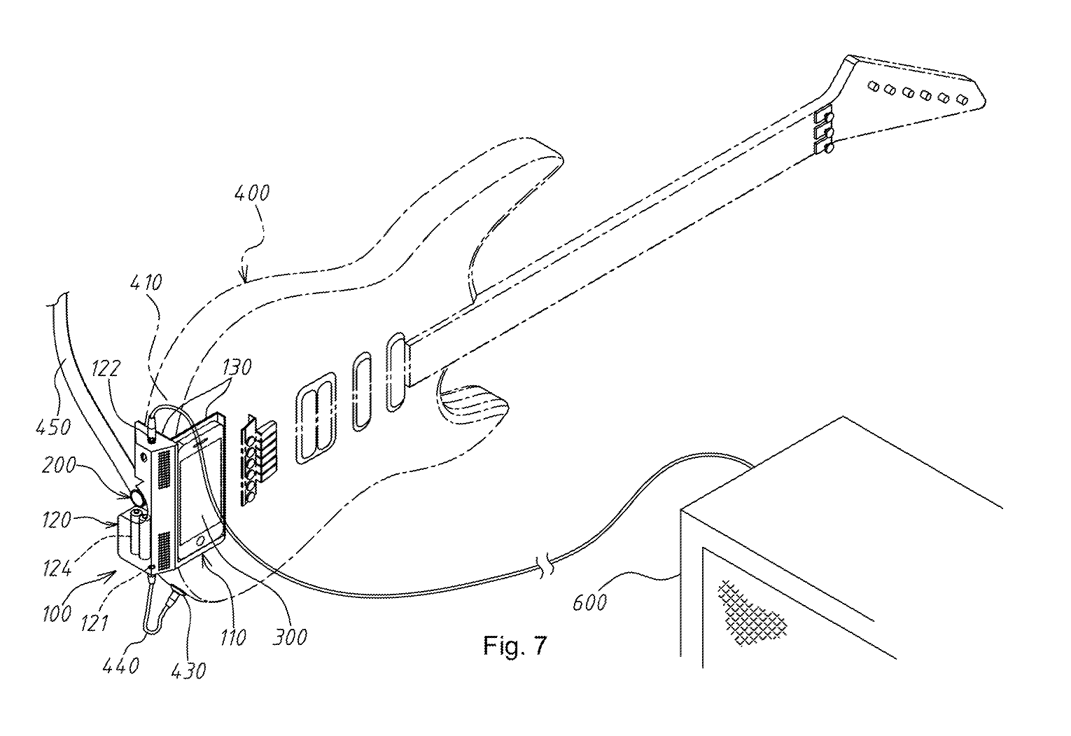

FIG. 6 and FIG. 7 show two schematic utilization views of the timbre processing adapter socket for electric guitar according to an embodiment of the present disclosure respectively. As shown in the drawings, an earphone 500 may be connected to the timbre processing signal output hole 122 (as shown in FIG. 6), such that for example when exercising at home, the player can listen to the processed music of the electric guitar individually, not disturbing other people. Alternatively, an outer voice box 600 may be connected to the timbre processing signal output hole 122 (as shown in FIG. 7) to improve the music playback effect of the electric guitar.

What is claimed is:

1. A timbre processing adapter socket for electric guitar, comprising:
a socket body, comprising:
a groove seat, wherein the groove seat has an accommodation groove and a signal transmitter is arranged on an inner end portion of the accommodation groove, such that a timbre processor is accommodated in the accommodation groove and electrically connected to the signal transmitter; and
an assembling seat, wherein the assembling seat is connected to the groove seat and is provided with a audio input hole, a timbre processing signal output hole, at least one speaker and at least one battery, wherein the audio input hole is electrically connected to the signal transmitter, the timbre processing signal output hole and the speaker is electrically connected to the timbre processor, and the battery is electrically connected to the speaker; and
a fixing unit fixing the socket body detachably on an external end portion of the electric guitar.

2. The timbre processing adapter socket for electric guitar of claim 1, wherein a screw fixing hole is arranged on the external end portion of the electric guitar, the assembling seat of the socket body has a combination plate in which an open slot is provided; the fixing unit comprises a screw fixing member and a fixing ring, wherein the screw fixing member has a hollow combination column and an outer block body which are integrated with each other, wherein the hollow combination column is provided with an external screw thread, and an internal screw protruding outwardly is accommodated in the hollow combination column, the fixing ring is provided with a screw hole for screwing to the external screw thread of the hollow combination column, the hollow combination column of the screw fixing member passes through the open slot, and the internal screw of the hollow combination column is screwed into the screw fixing hole, and the fixing ring is screwed tight to enforce the combination plate to move dose to the external end portion of the electric guitar.

3. The timbre processing adapter socket for electric guitar of claim 2, wherein a soft gasket is arranged on a surface of the fixing ring facing the socket body.

4. The timbre processing adapter socket for electric guitar of claim 2, wherein the connection between the assembling seat and the groove seat is shown as an L shape, and the groove seat and the assembling seat respectively cross against a top surface and a side surface of the external end portion of the electric guitar.

5. The timbre processing adapter socket for electric guitar of claim 4, wherein the groove seat and the assembling seat are respectively provided with a soft gasket on a surface facing the external end portion of the electric guitar.
